(19) United States
(12) Patent Application Publication
(10) Pub. No.: US 2015/0014259 A1
(43) Pub. Date: Jan. 15, 2015

(54) DUAL PARALLEL LATERAL WITH INTERNAL AIR DISTRIBUTION PIPE

(71) Applicant: XYLEM WATER SOLUTIONS ZELIENOPLE LLC, Zelienople, PA (US)

(72) Inventors: Christopher J. Ball, Cranberry Township, PA (US); Robert L. Wiley, III, New Castle, PA (US); John L. Geibel, Butler, PA (US); Randon L. Callen, Greensburg, PA (US); Brian J. Bates, Cranberry Township, PA (US); Ivan X. Zhu, Cranberry Township, PA (US)

(21) Appl. No.: 14/376,866

(22) PCT Filed: Feb. 6, 2013
(86) PCT No.: PCT/US2013/024923

§ 371 Date: Aug. 6, 2014

Related U.S. Application Data
(60) Provisional application No. 61/595,334, filed on Feb. 6, 2012.

(51) Int. Cl. B01D 24/46

(52) U.S. Cl. CPC B01D 24/4631
USPC 210/798; 210/151

(57) ABSTRACT

A dual parallel underdrain lateral for use in a filtration system having a filtration media includes a primary conduit extending along the underdrain lateral, which has a plurality of metering orifices for providing gas and liquid thereby; a secondary conduit, where the secondary conduit has a plurality of dispersion apertures in an upper side thereof to deliver the gas and liquid from the secondary conduit to the filtration media; and at least one gas conduit extending along the underdrain lateral, where the at least one gas conduit is connected to a gas source and is configured to provide the gas from the gas source directly to the primary conduit, or the secondary conduit, or any combination thereof.

### BACKGROUND OF THE INVENTION

1. Field of the Invention

The present invention relates to an underdrain lateral used for a filtration system, in particular, a dual parallel lateral with internal air distribution pipe used for a filtration system.

2. Description of Related Art

Lateral underdrains used for a filtration system are known in the art. See, for example, the lateral underdrains disclosed in U.S. Pat. No. 5,639,384 to Brown et al., which is hereby incorporated by reference as if set forth in its entirety herein. As shown in FIG. 1 of the reference, a gravity filtration system includes an underdrain lateral comprised of a plurality of filter underdrain blocks arranged end to end in parallel adjacent rows across a filter bottom, and a bed of granular media supported by the lateral underdrain. The gravity filtration system includes a flume with a backwash water inlet and a backwash inlet. As shown in FIG. 2 of the reference, the lateral underdrain includes a top wall, a bottom wall, a pair of side walls and interior walls, so that these walls form a primary horizontal conduit and two secondary horizontal conduits positioned on opposite sides of the primary horizontal conduit in the lateral underdrain. The interior walls which define the primary conduit have a plurality of air metering orifices, and the top wall which defines the secondary conduits has a plurality of dispersion apertures.

In the filtration mode, water to be filtered comes downward through granular media into secondary conduits and then goes to primary conduits. Primary conduits are connected to a collection flume, which in turn conveys the filtered liquid to a clearwell (not shown) for distribution to the consumer.

To maximize filter performance, the filtration system of the reference uses air and water backwash. That is, as shown in FIG. 2 of the reference, the pressurized air is introduced into the primary conduit so that an air/water interface is established in the primary conduit. The air is metered through orifices into the secondary conduit, where it bubbles through water therein up towards the portion of the underdrain block and creates an air/water interface and air pocket at the top of the secondary conduit of the underdrain lateral.

In case the air and water are being introduced at the same time into a common air and water chamber such as the primary conduit of the above reference, the variation in air and water rate is critical in the proper distribution of the combined air and water along the length of the underdrain lateral. If the air rate is too low or high, the air pocket in the primary conduit can not be maintained and proper air distribution is not maintained. More specifically, if the air rate is too low or the water rate is too high, the air pocket can not maintain enough depth to transport the air along the length evenly. The use of the common air and water chamber to transport air and water at the same time requires the combined air and water backwash rate to be in a very tight flow range without great deviation.

### SUMMARY OF THE INVENTION

According to a particular, non-limiting embodiment of the present invention, a dual parallel underdrain lateral is provided, which allows for an even gas and water distribution along the length of the underdrain lateral over a broader range of combined gas and water backwash rate. According to one embodiment of the present invention, a dual parallel underdrain lateral is provided. The dual parallel underdrain lateral includes a primary conduit extending along the underdrain lateral, which has a plurality of metering orifices for providing gas and liquid thereby; a secondary conduit that has a plurality of dispersion apertures in an upper side thereof to deliver the gas and liquid from the secondary conduit to the filtration media; and at least one gas conduit extending along the underdrain lateral, where the at least one gas conduit is connected to a gas source and is configured to provide the gas from the gas source directly to the primary conduit, or the secondary conduit, or any combination thereof. The gas conduit may have a plurality of gas exit orifices along the length of the gas conduit.

According to another embodiment of the present invention, a filtration system is provided. The filtration system includes a filtration media for filtering a process liquid and dual parallel underdrain laterals arranged under the filtration media. The dual parallel underdrain laterals comprise a primary conduit extending along the underdrain lateral, which has a plurality of metering orifices for providing gas and liquid thereby; a secondary conduit into which gas and liquid may be metered from the primary conduit through the metering orifices, wherein, the secondary conduit has a plurality of dispersion apertures in an upper side thereof to deliver the gas and liquid from the secondary conduit to the filtration media; and at least one gas conduit extending along the underdrain lateral, where the at least one gas conduit is connected to a gas source and is configured to provide the gas from the gas source directly to the primary conduit, or the secondary conduit, or any combination thereof.

According to another embodiment of the present invention, a method of backwashing a filtration media is provided. The method includes a step of supplying a gas under pressure into at least one gas conduit arranged within a dual parallel underdrain lateral which is arranged under the filtration media and has a primary conduit and a secondary conduit therein, a step of forming a gas pocket in at least the secondary conduit, and a step of providing the gas to the filtration media through dispersion apertures in a wall of the dual parallel underdrain lateral.

Further details and advantages of the invention will become clear upon reading the following detailed description in conjunction with the accompanying drawing figures, wherein like parts are designated with like reference numerals throughout.

### BRIEF DESCRIPTION OF THE DRAWINGS

FIG. 1 is a schematic view of a filter 10, to which the present invention is applied, having underdrain laterals 12 supporting a filtration media.

FIG. 2 is a sectional view of a one embodiment of an underdrain lateral 12 of the present invention.

FIG. 3 is a schematic view of an underdrain lateral 12, illustrating one embodiment of the air feed chamber.

FIG. 4 is a schematic view of an underdrain lateral 12, illustrating another embodiment of the air feed chamber.

FIG. 5 is a sectional view of one embodiment of an underdrain lateral 12 of the present invention.

FIG. 6 is a sectional view of another embodiment of an underdrain lateral 12 of the present invention.

FIG. 7 is a sectional view of yet another embodiment of an underdrain lateral 12 of the present invention.

### DESCRIPTION OF THE PREFERRED EMBODIMENTS

For purposes of the description hereinafter, the terms “end”, “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the specification, are simply exemplary embodiments of the invention. Hence, specific dimensions and other physical characteristics related to the embodiments disclosed herein are not to be considered as limiting. Further, it is to be understood that the invention may assume various alternative variations and step sequences, except where expressly specified to the contrary.

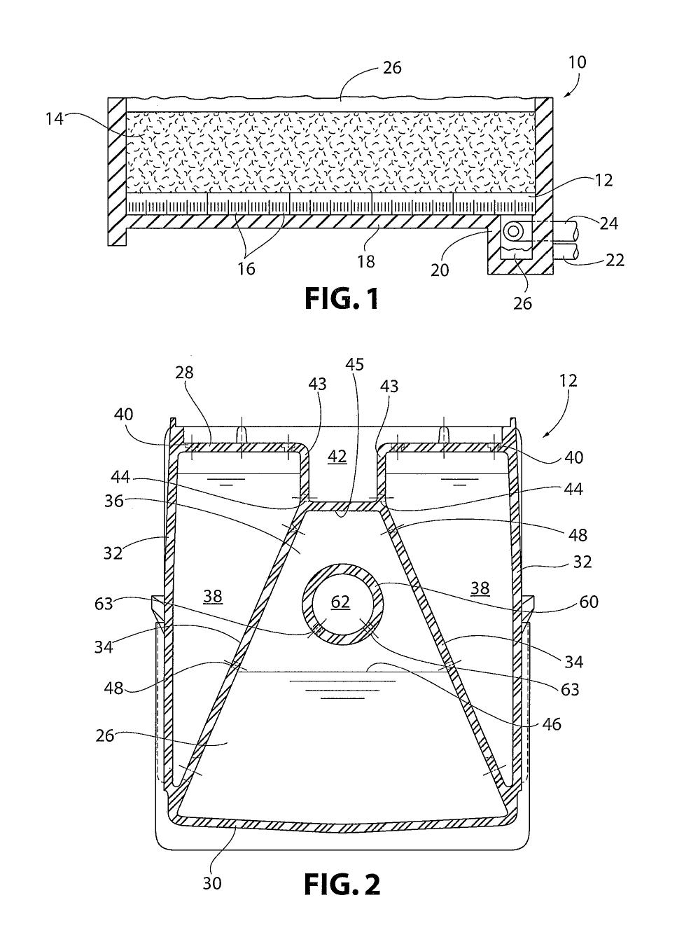

FIG. 1 illustrates a gravity filter 10 having underdrain laterals 12 supporting a bed of granular media 14 as a filtration media. The underdrain lateral 12 is comprised of a plurality of filter underdrain blocks 16 arranged end to end in parallel adjacent rows across a filter bottom 18. The gravity filter 10 includes a flume 20 with a backwash water inlet 22 and a backwash air inlet 24. Further aspects of gravity filters having underdrain laterals, to which the present invention may be applied, may be found in U.S. Pat. No. 5,639,384 to Brown et al., incorporated herein by reference.

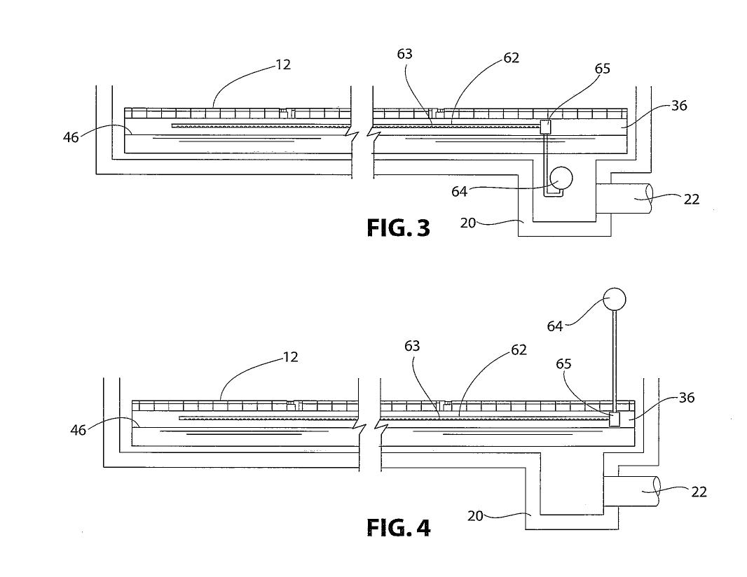

The first embodiment of the present invention is illustrated in FIGS. 2 and 3. Particularly, FIG. 2 illustrates an underdrain lateral 12 having a top wall 28, bottom wall 30, and a pair of opposing side walls 32 extending between top wall 28 and bottom wall 30. A plurality of internal walls 34 divide the hollow interior of the lateral 12 into a primary horizontal conduit 36 and two secondary horizontal conduits 38, positioned on opposite sides of the primary horizontal conduit 36. Furthermore, the underdrain lateral 12 includes an air conduit pipe 60 arranged within and along the primary conduit 36, which provides an air conduit 62 therein. It is recognized that the air conduit pipe 60 can distribute other types of gas other than air.

Top wall 28 includes a plurality of dispersion apertures 40 which are slightly recessed from the outer surface of the top wall 28 in counter sinks. A preferred lateral block 12 according to the first embodiment is typically about four feet long and includes 92 dispersion apertures 40, evenly spaced across the top wall 28 thereof. The dispersion apertures 40 are preferably but not exclusively 7/32″ to ¼″ in diameter. The top wall 28 is approximately 9″ wide, and dispersion apertures 40 are spaced at a frequency of 23 apertures per linear foot of the underdrain block 16.

A trough 42 is centrally located in top wall 28, and a plurality of orifices 44 are positioned on each side of the trough 42 near the bottom wall 45 of the trough 42. The orifices 44 serve as drag water return conduits. In the current preferred embodiment, these orifices 44 are ¼″ in diameter, and six orifices are located on each side 43 of the trough 42. The orifices 44 are linearly spaced on 8″ centers along the longitudinal axis of block 16. Furthermore, the orifices 44 are staggered so that they are not symmetrically opposed from one another on opposing trough sides 43.

As shown in FIG. 2, the air conduit pipe 60 includes a plurality of air discharge orifices 63 which provide pressurized air from the air conduit 62 to the primary conduit (common air and water chamber) 36 therethrough. As shown in FIG. 3, the air conduit 62 is connected to an air feed chamber 64 arranged in the flume 20 via an adaptor 65.

In the filtration mode, water to be filtered comes downward through granular media 14 into non-clog dispersion apertures 40 and trough orifices 44. From there, the water passes to secondary conduits 38 and then to primary conduits 36. Primary conduits 36 are connected to a collection flume 20, which in turn conveys the filtered liquid to a clearwell (not shown) for distribution to the consumer. It is appreciated that the filtration systems of the present invention can be used to filter water and wastewater for municipal or industrial applications.

In the backwash mode, clean water and air is pumped upward through the granular media 14 to dislodge dirt and foreign particles from the granular media 14. According to the present invention, pressurized air is pumped from the air feed chamber 64 into the air conduit 62, and clean water is also pumped from the backwash water supply (backwash water inlet) 22 into the primary conduit 36. The pressurized air is transported along the entire length of the air conduit 62 and is metered through the air discharge orifices 63 to the primary conduit 36, so that the air/water interface 46 is established and the air pocket is developed in the upper side of the primary conduit 36. Furthermore, the air is metered through the air metering orifices 48 of the interior walls 34, so that the air pocket is developed in the upper side of the secondary conduits 38.

In order to distribute the air and water evenly along the length of the underdrain laterals 12, the depth of the air pocket and water pocket in both conduits are critical in the distribution of the fluids along the length of the laterals. According to the present invention, since the air conduit 62 for providing the pressurized air is arranged separately from the other conduit, the air is easily transported along the entire length of the underdrain lateral 12 and is easily distributed via the air discharge orifices 63 along the length of the air conduit 62. Therefore, air and water backwash rate (air and water flow rate) may be in an extremely broad range without great deviation.

The air conduit 62 does not have to run the entire length of the lateral. The air orifices along the air conduit 62 may be spaced at varying locations and do not have to be evenly spaced. As the air exits the separate air conduit 62 into the common air and water primary chamber of the underdrain, the air is redistributed further along the length of the underdrain by means of the air pocket formed within the primary conduit 36.

FIG. 4 illustrates another embodiment of the present invention. In this embodiment, the air feed chamber 64 for providing the pressurized air to the air conduit 62 is arranged above the underdrain laterals 12.

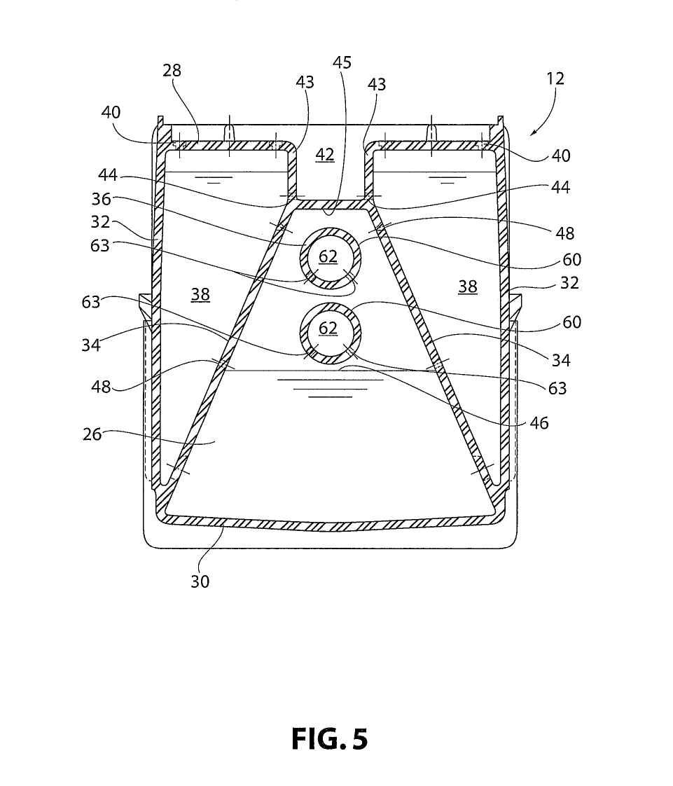

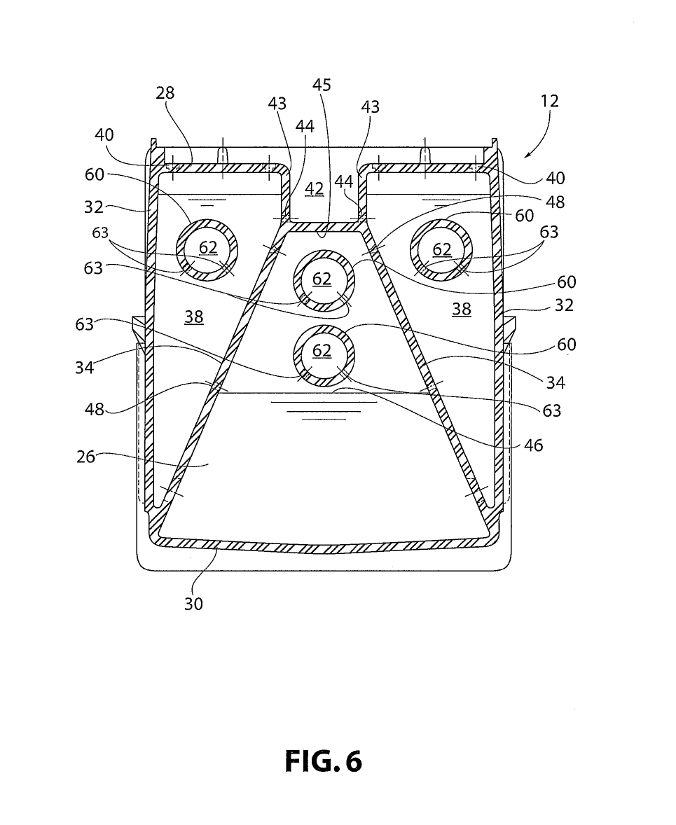

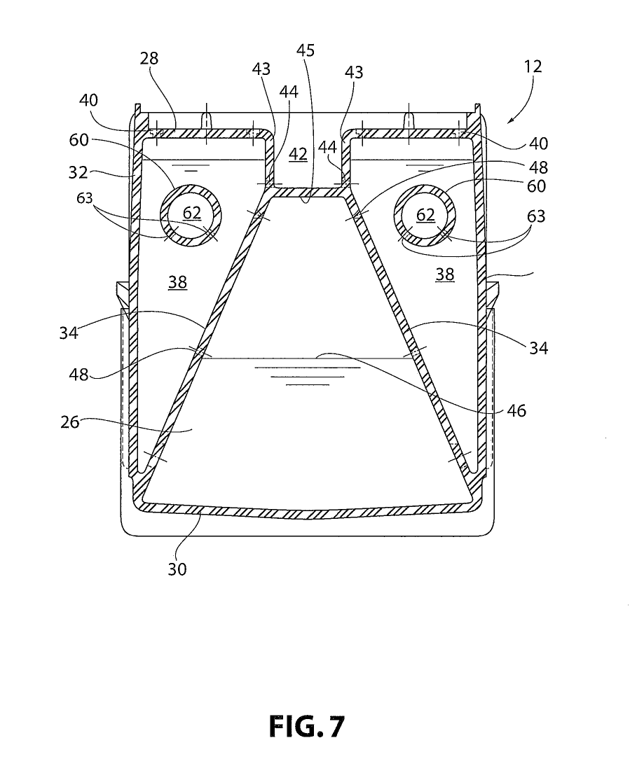

In another embodiment according to the present invention, the underdrain lateral 12 includes a plurality of air conduit pipes 60. As used herein, the term “plurality” refers to two or more of the items used in conjunction with the term. For example, a plurality of air conduit pipes 60 may refer to two or more air conduit pipes 60. As shown in FIG. 5, the underdrain lateral 12 can include at least two air conduit pipes 60 arranged within and along the primary conduit 36. Alternatively, referring to FIG. 6, the underdrain lateral 12 can include at least one air conduit pipe 60 arranged within and along the primary conduit 36, and at least one air conduit pipe 60 arranged within and along at least one of the secondary conduits 38.

FIG. 6 illustrates yet another embodiment of the present invention. In this embodiment, air conduit pipes 60 are arranged within and along the secondary conduits 38 only. Pressurized air is transported along the entire length of the air conduit 62 and is metered through the air discharge orifices 63 to secondary conduits 38, so that an air pocket is developed in the secondary conduits 38.

It should be recognized that various arrangements of multiple air conduit pipes 60 within the primary 36 and/or secondary 38 conduits can be used with the underdrain laterals 12 of the present invention.

In addition to gravity flow filtration, the present invention can be used in other filtration methods. For instance, the underdrain laterals 12 of the present invention can also be used for up-flow filtration. In an up-flow filtration system, water is introduced through the flume 20 and then up through the underdrain lateral 12. The water then exits through the top of the underdrain lateral 12 and filter media 14. During up-flow filtration, air flows in at an air rate less than the typical air-scour rate used during backwashing. For instance, in one embodiment according to an up-flow filtration system, air flows at an air rate of less than 1.5 standard cubic feet per minute per square foot of filter area (scfm/ft²).

Although the invention has been described in detail for the purpose of illustration based on what is currently considered to be the most practical and preferred embodiments, it is to be understood that such detail is solely for that purpose and that the invention is not limited to the disclosed embodiments but, on the contrary, is intended to cover modifications and equivalent arrangements that are within the spirit and scope of the description. For example, it is to be understood that the present invention contemplates that, to the extent possible, one or more features of any embodiment can be combined with one or more features of any other embodiment.

The invention claimed is:

1. A dual parallel underdrain lateral for use in a filtration system having a filtration media comprising:
a primary conduit extending along the underdrain lateral, which has a plurality of metering orifices for providing gas and liquid thereby;
a secondary conduit, wherein the secondary conduit has a plurality of dispersion apertures in an upper side thereof to deliver the gas and liquid from the secondary conduit to the filtration media; and
at least one gas conduit extending along the underdrain lateral, wherein the at least one gas conduit is connected to a gas source and is configured to provide the gas from the gas source directly to the primary conduit, or the secondary conduit, or any combination thereof.

2. The dual parallel underdrain lateral according to claim 1, wherein the at least one gas conduit is positioned within the primary conduit.

3. The dual parallel underdrain lateral according to claim 1, wherein the at least one gas conduit is positioned within the secondary conduit.

4. The dual parallel underdrain lateral according to claim 1, wherein at least one gas conduit is positioned within the primary conduit and at least a second gas conduit is positioned within the secondary conduit.

5. The dual parallel underdrain lateral according to claim 1, wherein the at least one gas conduit has a plurality of gas exit orifices along the length of the at least one gas conduit.

6. The dual parallel underdrain lateral according to claim 1, wherein the dual parallel underdrain lateral is used in a gravity filtration system.

7. The dual parallel underdrain lateral according to claim 1, wherein the dual parallel underdrain lateral is used in an up-flow filtration system.

8. A filtration system comprising a filtration media for filtering a process liquid and a dual parallel underdrain lateral arranged under the filtration media, wherein the dual parallel underdrain laterals comprise:
a primary conduit extending along the underdrain lateral, which has a plurality of metering orifices for providing gas and liquid thereby;
a secondary conduit, wherein the secondary conduit has a plurality of dispersion apertures in an upper side thereof to deliver the gas and liquid from the secondary conduit to the filtration media; and
at least one gas conduit extending along the underdrain lateral, wherein the at least one gas conduit is connected to a gas source and is configured to provide the gas from the gas source directly to the primary conduit, or the secondary conduit, or any combination thereof.

9. The filtration system according to claim 8, wherein the at least one gas conduit is positioned within the primary conduit.

10. The filtration system according to claim 8, wherein the at least one gas conduit is positioned within the secondary conduit.

11. The filtration system according to claim 8, wherein at least one gas conduit is positioned within the primary conduit and at least a second gas conduit is positioned within the secondary conduit.

12. The filtration system according to claim 8, wherein the at least one gas conduit has a plurality of gas exit orifices along the length of the at least one gas conduit.

13. The filtration system according to claim 8, wherein the filtration system comprises a gravity filtration system.

14. The filtration system according to claim 8, wherein the filtration system comprises an up-flow filtration system.

15. A method of backwashing a filtration media comprising a step of supplying a gas under pressure into at least one gas conduit arranged within a dual parallel underdrain lateral which is arranged under the filtration media and has a primary conduit and a secondary conduit therein, a step of forming a gas pocket in at least the secondary conduit, and a step of providing the gas to the filtration media through dispersion apertures in a wall of the dual parallel underdrain lateral.

16. The method according to claim 15, wherein the at least one gas conduit is positioned within the primary conduit.

17. The method according to claim 16, further comprising a step of forming a gas pocket in the primary conduit.

18. The method according to claim 15, wherein the at least one gas conduit is positioned within the secondary conduit.

19. The method according to claim 15, wherein at least one gas conduit is positioned within the primary conduit and at least a second gas conduit is positioned within the secondary conduit.

20. The method according to claim 19, further comprising a step of forming a gas pocket in the primary conduit.
